(19) United States
(12) Patent Application Publication
(10) Pub. No.: US 2024/0083326 A1
(43) Pub. Date: Mar. 14, 2024

(54) VOICE AND MANUALLY POWERED RETRACTABLE AUTOMOBILE CUP HOLDER

(71) Applicant: Kenneth - Kamman, Bloomfield, MI (US)

(72) Inventor: Kenneth - Kamman, Bloomfield, MI (US)

(21) Appl. No.: 17/943,016

(22) Filed: Sep. 12, 2022

(51) Int. Cl. B60N 3/10; B60R 16/037

(52) U.S. Cl. CPC B60N 3/102; B60R 16/0373

(57) ABSTRACT

A powered retractable automobile cup holder controlled manually or by voice activation, whereby the cup holder is a rectangular metal or wood object with two holes for cups mounted to a stud along with a linear actuator attached to the vehicle support structure. An actuation rod is attached to one end of the linear actuator and the other end to the cup holder. A 6- or 12-volt power source supplies power to the manual electrical switch, a voice activation module and the linear actuator. The linear actuator along with an attached actuating rod rotates the cup holder about the mounting stud out from under the instrument panel of the vehicle for usage. The stud, or pivot point, which is attached to the vehicle support structure can be mounted to existing attachment points on the vehicle under the instrument panel via a bracket which will eliminate the necessity for the drilling of holes, cutting or welding. One of the objectives of this invention is to not alter any vehicle structure or componentry, maintaining 100% of the vehicle's authenticity.

### BACKGROUND OF THE INVENTION

### 1. Field of the Invention

The present invention relates to a retractable cup holder for a motor vehicle, boat or home use. More specifically, this invention involves a cup holder whereby the initial design intent was for it to be stowed under a vehicle instrument panel and automatically rotate outward to conveniently secure cups with beverages. The cup holder is powered outward with an audible voice command or the operation of a switch and can subsequently retract out of the way back under the vehicle instrument panel. Although this invention can be utilized for many motor vehicles, the application of this invention is intended for older vintage and antique motor vehicles but can also be adapted for other applications such as in a boat or home use.

### 2. Prior Background

Motor vehicles did not have cup holders until the introduction of Chrysler's 1984 Plymouth Voyager Mini-Van. There are hundreds of thousands of older motor vehicles registered today which do not have a cup holder. After market cup holders today require vehicle modification for installation and then manual operation for use. Vehicle modifications for these requires removing componentry, cutting or drilling for installation. This invention allows for a powered retractable cup holder without any defacement to the vehicle. There is no cutting, welding, drilling or component removal to install this invention. The cup holder automatically moves out from under the instrument panel for use with the flip of a switch or with hands free voice activation and then can be rotated out of the way after use. It can be easily removed from the vehicle, if desired, without any sign of its original installation.

### DETAILED DESCRIPTION OF THE PREFERRED EMBODIMENTS

Referring to FIG. 1, the Voice and Manually Powered Retractable Automobile Cup Holder invention is shown with all the vehicle embodiments involved. Shown in the FIG. 1. diagram is a power source 1 which supplies 6 volts DC or 12 volts DC power 2 to a Manual Throw Switch 3 and a Voice Activated Control Module both mounted under the vehicle instrument panel. The Switch 3 and Voice Activated Switch 5 both provide power 4 to a Linear Actuator 6 which is attached to vehicle Support Structure 9 on one end and an Actuating Rod 8 on the other end. The Linear Actuator 6 when powered by Switch 3 or 5 moves the Actuating Rod 6 of which its other end is attached to Cup Holder 7 and rotates Cup Holder 7 out from under the vehicle instrument panel to allow usage. The Linear Actuator 6 together with Cup Holder 7 are both attached to Support Structure 9 which is a single point attachment under the vehicle instrument panel. The attachment can be any rigid structural component with existing holes or attachment points.

Referring to FIG. 2, shown is the top view and side (rear) view of the operating geometry of the invention. The Cup Holder pivots about a fixed point rigidly attached to the vehicle Support Structure. The Actuator is also attached to the same vehicle Support Structure. An actuating rod which is attached to the actuating end of the linear actuator rotates the Cup Holder about its pivot point moving the Cup Holder out from under the instrument panel for usage. The Single Throw Switch or the choice of voice control, where the Voice Activated Control Module also switches power to the Actuator, allowing the Cup Holder to rotate out and in.

Referring to FIG. 3, shown is a schematic of the electronic operation of the invention. The wiring diagram depicts how the Single Throw Switch and the Voice Activated Control Module provides reversible power to the Actuator. The two Relays shown in the schematic reverse the polarity controlling two-way movement of the Actuator.

Referring to FIG. 4, shown is an illustration of a vehicle instrument panel with the cup holder swung outward for usage.

### BRIEF DESCRIPTION OF THE DRAWINGS

The preferred embodiments of the invention are disclosed in the following description and in the accompanying drawings, wherein:

FIG. 1. is a schematic diagram of all the vehicle embodiments involved in the invention.

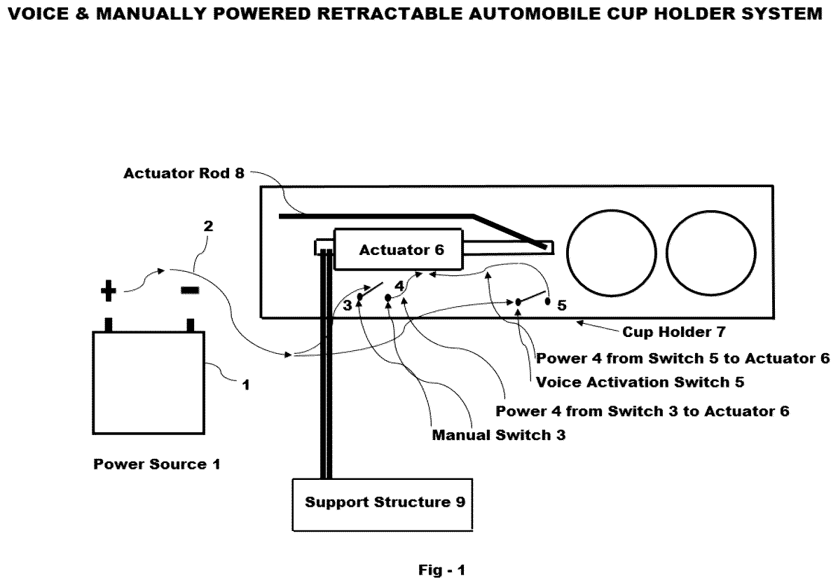

FIG. 2. is a top view and a side (rear) view of the mechanical component operation and component geometry of the invention.

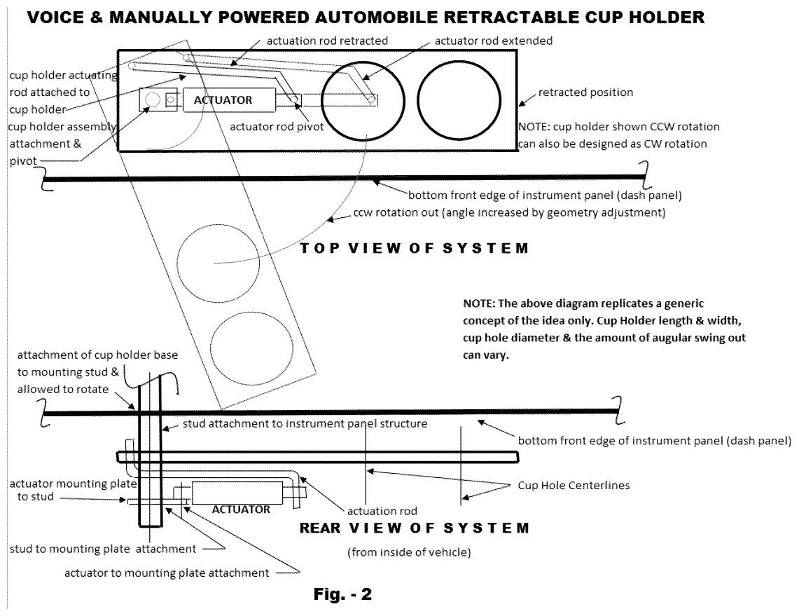

FIG. 3. is a schematic of the electronics necessary to allow the invention to function.

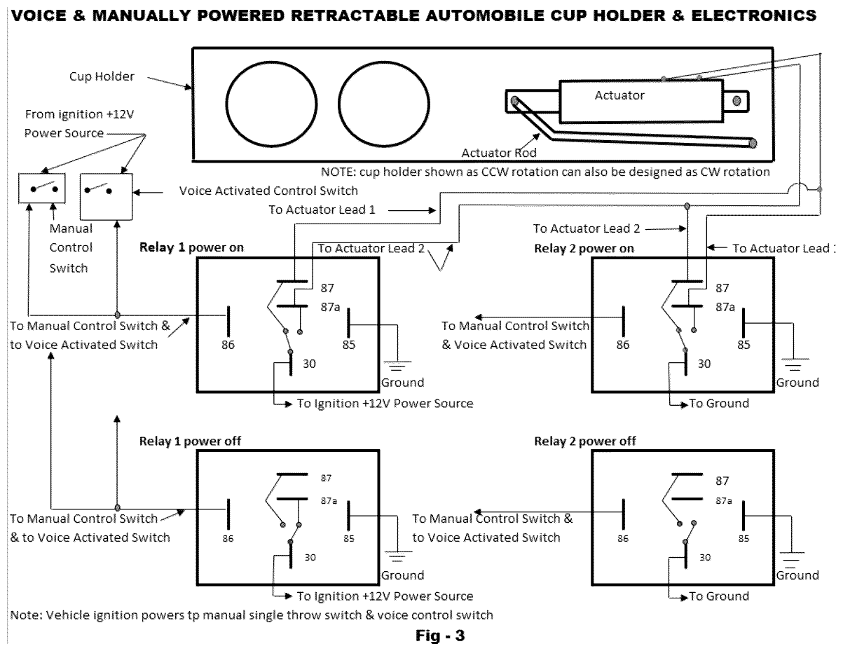

FIG. 4. is an illustration representing the location and operation in an automobile.

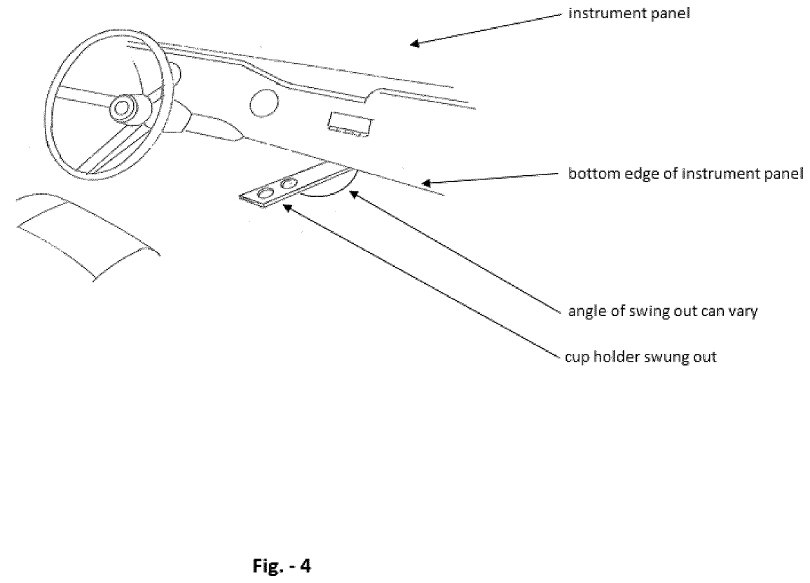

### SUMMARY OF THE INVENTION

According to the present invention, this voice and manually powered retractable cup holder system for a motor vehicle is primarily intended for vintage and antique motor vehicles. The motor vehicle having a support structure comprises the cup holder which is a flat rectangular object (wood, metal, other) which rotates, a linear actuator, an electronically powered switch, an alternately voice activated control switch and a power source. The retractable automobile cup holder further comprises a bracket mounted on vehicle structure which is attached to the linear actuator and cup holder and allows rotation of the cup holder when power is applied. The rotation exposes the cup holder out from under the vehicle instrument panel allowing usage.

1. A voice and manually powered retractable automobile cup holder for a vehicle having a component support structure and a power source, the system comprising:
a. the cup holder which is a flat rectangular object having two holes for cups (wood or metal) which is attached to a stud which is attached to the vehicle support structure;
b. a linear actuator attached to the stud;
c. the actuating rod attached to the linear actuator on one end and the cup holder on the other end;
d. the stud attached to the vehicle support structure which is also the pivot point by which the cup holder pivots outward for usage;
e. the linear actuator having two power input wires, one wire for one direction of movement and the other wire for the opposite direction of movement;
f. a 6 volt or 12 volt continuous power supply;
g. a manually controlled electronic switch mounted to the vehicle support structure under the instrument panel to provide power to the linear actuator;
h. a voice activation module providing power to the linear actuator;
i. a continuous power source to the switch.

2. The powered retractable cup holder of claim 1 involves outward angular movement out from under the vehicle instrument panel.

3. The attachment and installation of the powered retractable cup holder system requires no modification or degradation to the vehicle or any of the vehicle componentry and can be removed without any sign of installation maintaining authenticity of the vehicle.

4. The powered retractable cup holder is operated with the flip of a switch out from under the instrument panel and back under the instrument panel.

5. The powered retractable cup holder can also be operated audibly by voice commands.
